(19) United States
(12) Patent Application Publication
(10) Pub. No.: US 2015/0100387 A1
(43) Pub. Date: Apr. 9, 2015

(54) PROVIDING GUIDANCE TO A BUSINESS ORGANIZATION BY ONE OR MORE OF A PLURALITY OF BUSINESS ADVISOR MODULES

(71) Applicant: International Business Machines Corporation, Armonk, NY (US)

(72) Inventors: FRANCIS X. REDDINGTON, SARASOTA, FL (US); NEIL SAHOTA, COSTA MESA, CA (US)

(73) Assignee: International Business Machines Corporation, Armonk, NY (US)

(21) Appl. No.: 14/047,856

(22) Filed: Oct. 7, 2013

(51) Int. Cl. G06Q 10/06

(52) U.S. Cl. CPC G06Q 10/0637
USPC 705/7.36

(57) ABSTRACT

Providing guidance to a business organization by one or more of a plurality of business advisor modules, including: receiving, by a business advisor module, one or more business objectives; receiving, by the business advisor module, one or more key artifacts; and creating, by the business advisor module in dependence upon the one or more business objectives and the one or more key artifacts, a business recommendation.

### BACKGROUND OF THE INVENTION

1. Field of the Invention

The field of the invention is data processing, or, more specifically, methods, apparatus, and products for providing guidance to a business organization by one or more of a plurality of business advisor modules.

2. Description of Related Art

Managers and other evaluators of a business entity have metrics they want to see met and will frequently design processes around those metrics. This approach can frequently lead to failure as misguided metrics can drive organizational behavior and adversely create unintentional side effects. Many managers don't understand the consequences of unintended cause and effect as a result of misguided directives. For example the singular focus of increase profits without a known balanced approach, can lead management to concentrate on cutting cost to the point of affecting both employee morale and existing customer satisfaction, and inadvertently decreasing profits in the long run.

### SUMMARY OF THE INVENTION

Methods, apparatuses, and products for providing guidance to a business organization by one or more of a plurality of business advisor modules, including: receiving, by a business advisor module, one or more business objectives; receiving, by the business advisor module, one or more key artifacts; and creating, by the business advisor module in dependence upon the one or more business objectives and the one or more key artifacts, a business recommendation.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in providing guidance to a business organization by one or more of a plurality of business advisor modules according to embodiments of the present invention.

FIG. 2 sets forth a flow chart illustrating an example method for providing guidance to a business organization by one or more of a plurality of business advisor modules according to embodiments of the present invention.

FIG. 3 sets forth a flow chart illustrating an example method for providing guidance to a business organization by one or more of a plurality of business advisor modules according to embodiments of the present invention.

FIG. 4 sets forth a flow chart illustrating an example method for providing guidance to a business organization by one or more of a plurality of business advisor modules according to embodiments of the present invention.

FIG. 5 sets forth a flow chart illustrating an example method for providing guidance to a business organization by one or more of a plurality of business advisor modules according to embodiments of the present invention.

FIG. 6 sets forth a flow chart illustrating an example method for providing guidance to a business organization by one or more of a plurality of business advisor modules according to embodiments of the present invention.

FIG. 7 sets forth a flow chart illustrating an example method for providing guidance to a business organization by one or more of a plurality of business advisor modules according to embodiments of the present invention.

FIG. 8 sets forth a flow chart illustrating an example method for providing guidance to a business organization by one or more of a plurality of business advisor modules according to embodiments of the present invention.

### DETAILED DESCRIPTION OF EXAMPLE EMBODIMENTS

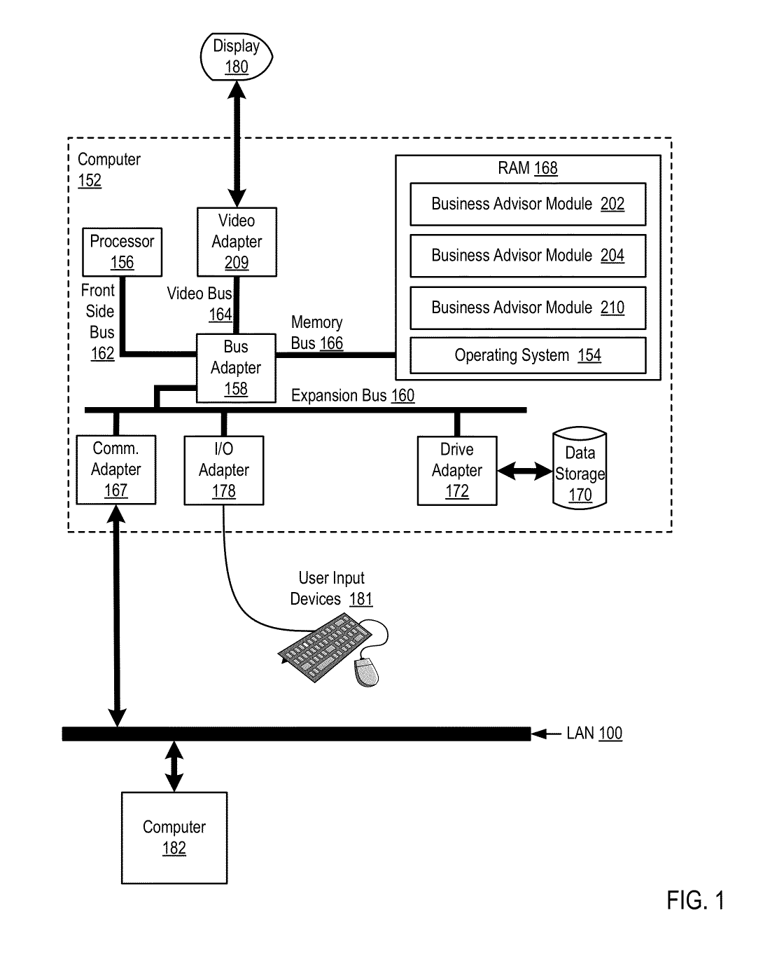

Example methods, apparatuses, and products for providing guidance to a business organization by one or more of a plurality of business advisor modules in accordance with the present invention are described with reference to the accompanying drawings, beginning with FIG. 1. FIG. 1 sets forth a block diagram of automated computing machinery comprising an example computer (152) useful in providing guidance to a business organization by one or more of a plurality of business advisor modules according to embodiments of the present invention. The computer (152) of FIG. 1 includes at least one computer processor (156) or ‘CPU’ as well as random access memory (168) (RAM′) which is connected through a high speed memory bus (166) and bus adapter (158) to processor (156) and to other components of the computer (152).

Stored in RAM (168) are one or more business advisor modules (202, 204, 210). The business advisor modules (202, 204, 210) of FIG. 1 may be embodied, for example, as modules of computer program instructions executing on computer hardware. The business advisor modules (202, 204, 210) may be configured to evaluate and manage various business initiatives such as, for example, cost cutting initiatives, acquisition initiatives, and so on. The business advisor modules (202, 204, 210) may be configured to provide guidance to a business organization by: receiving, by a business advisor module (202, 204, 210), one or more business objectives; receiving, by the business advisor module (202, 204, 210), one or more key artifacts; and creating, by the business advisor module (202, 204, 210) in dependence upon the one or more business objectives and the one or more key artifacts, a business recommendation, as described in greater detail below.

Also stored in RAM (168) is an operating system (154). Operating systems useful providing guidance to a business organization according to embodiments of the present invention include UNIX™, Linux™, Microsoft XP™, AIX™, IBM's i5/OS™, and others as will occur to those of skill in the art. The operating system (154) and the business advisor modules (202, 204, 210) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for providing guidance to a business organization according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for providing guidance to a business organization according to embodiments of the present invention include modems for wired dial-up communications, Ethernet (IEEE 802.3) adapters for wired data communications network communications, and 802.11 adapters for wireless data communications network communications.

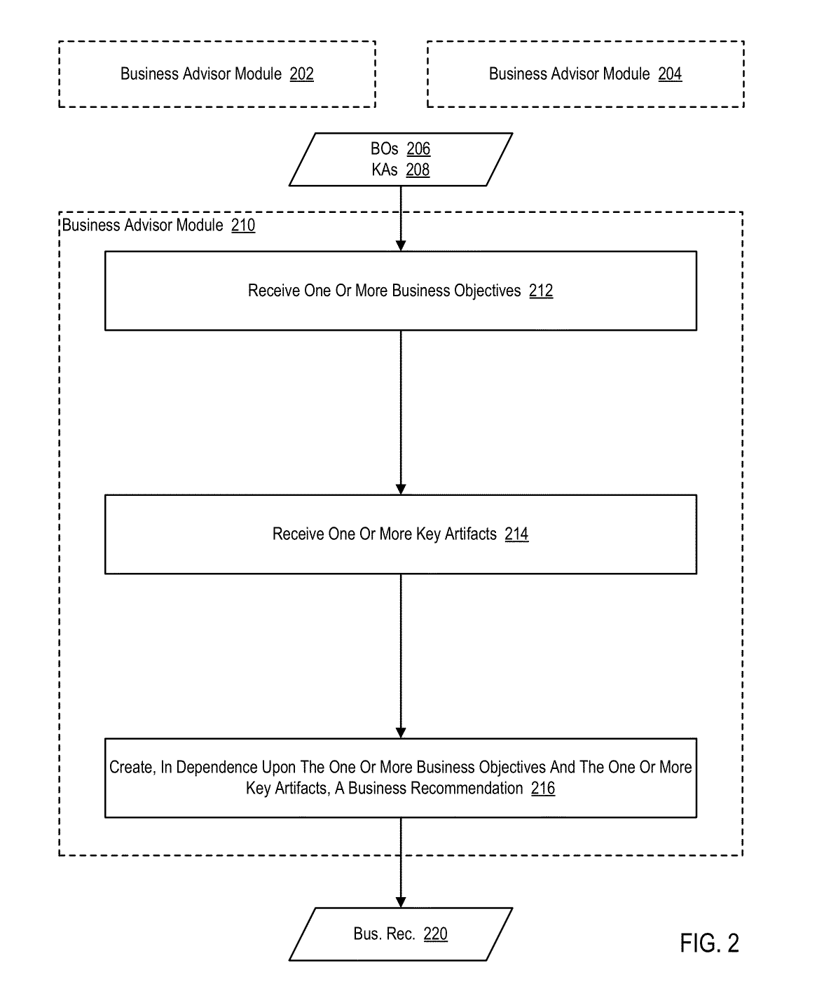

For further explanation, FIG. 2 sets forth a flow chart illustrating an example method for providing guidance to a business organization by one or more of a plurality of business advisor modules (202, 204, 210) according to embodiments of the present invention. In the example method of FIG. 2, the business advisor modules (202, 204, 210) may be embodied, for example, as a module of computer program instructions executing on computer hardware. The business advisor modules (202, 204, 210) of FIG. 2 may be configured to evaluate and manage various business initiatives such as, for example, cost cutting initiatives, acquisition initiatives, and so on.

The example method of FIG. 2 includes receiving (212), by a business advisor module (210), one or more business objectives (206). In the example method of FIG. 2, the one or more business objectives (206) may be embodied, for example, as data structures that include information useful in evaluating the impact of pursuing various business initiatives. The one or more business objectives (206) may include, for example, information describing one or more business goals or objectives of a business organization. For example, the one or more business objectives (206) may include information describing cost reduction goals of a business organization, information describing expansion goals of the business organization, information describing cultural goals of the business organization, and so on.

The example method of FIG. 2 also includes receiving (214), by the business advisor module (210), one or more key artifacts (208). In the example method of FIG. 2, the one or more key artifacts (208) may be embodied, for example, as data structures that include information useful in determining whether a business organization should pursue one or more business initiatives. The one or more key artifacts (208) may include, for example, quantifiable metrics associated with the forecasted impact of pursuing a particular business initiative such as the forecasted cost of pursuing a business initiative, the forecasted benefit of pursuing a business initiative, and the forecasted direct and indirect impacts on the operation of a business initiative, and so on. In addition, the one or more key artifacts (208) may also include information identifying the current state of a business organization such as, for example, the amount of money that a business organization has available for pursuing a particular business initiative, the amount of employee hours that a business organization has available for pursuing a particular business initiative, an inventory of business assets that may be utilized in pursuit of a particular business initiative, and so on. In such a way, the key artifacts (208)) represent quantifiable metrics that can be used to determine whether pursuing a particular business initiative would be beneficial for a business organization and whether pursing a particular business initiative would take the business organization closer to or further away from their goals and objectives.

The example method of FIG. 2 includes creating (216), by the business advisor module (210) in dependence upon the one or more business objectives (206) and the one or more key artifacts (208), a business recommendation (220). In the example method of FIG. 2, the business recommendation (220) can include, for example, information outlining the projected impact of pursuing one or more business initiatives that will be experienced by the business organization, information ranking the value of a plurality of business initiatives to a business organization, information identifying a recommended course of action for pursuing a particular business initiative, and so on. In the example method of FIG. 2, the business recommendation (220) may be delivered to organizational heads and used to determine whether to pursue a business initiative and to determine how to pursue the business initiative.

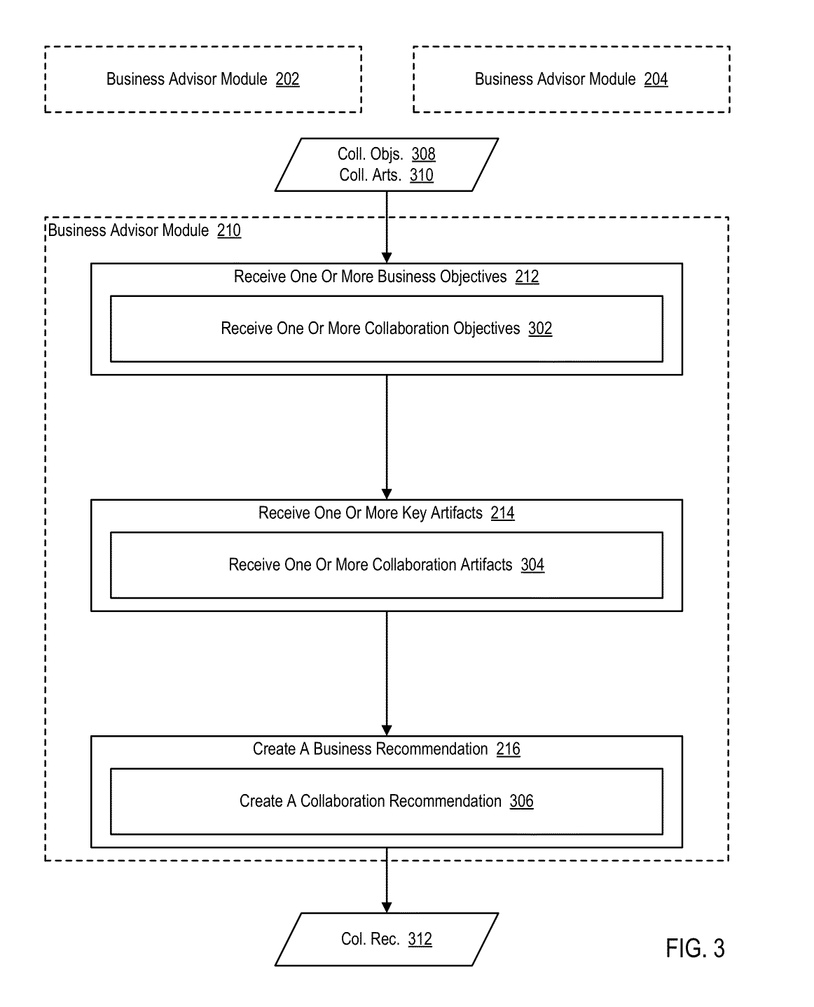

For further explanation, FIG. 3 sets forth a flow chart illustrating an additional example method for providing guidance to a business organization by one or more of a plurality of business advisor modules (202, 204, 210) according to embodiments of the present invention. The example method of FIG. 3 is similar to the example method of FIG. 2, as it also includes receiving (212) one or more business objectives (206), receiving (214) one or more key artifacts (208), and creating (216) a business recommendation (220) in dependence upon the one or more business objectives (206) and the one or more key artifacts (208).

In the example method of FIG. 3, the business advisor module (210) is a collaboration advisor. In the example method of FIG. 3, a collaboration advisor may be embodied, for example, as a module of computer program instructions executing on computer hardware. The collaboration advisor may be configured, for example, to evaluate partnership efforts between multiple groups, such as independent groups within the same business organization. For example, the collaboration advisor may evaluate partnership efforts between a manufacturing group within a business organization and a distribution group with the same business organization. The collaboration advisor may also be configured to evaluate partnership efforts between one or more groups within a business organization and one or more groups outside of the business organization. For example, the collaboration advisor may drive work coordination between a manufacturing group within a business organization and a group within a distinct distribution company that the business organization is partnered with.

In the example method of FIG. 3, receiving (212) one or more business objectives includes receiving (302) one or more collaboration objectives (308). In the example method of FIG. 3, the one or more collaboration objectives (308) may be embodied, for example, as data structures that include information useful in identifying the goals and objectives to be achieved by a partnership between multiple groups. The one or more collaboration objectives (308) may include, for example, information describing the strategic plans of a business organization, information describing the strategic plans of a group participating in a partnership, information describing the project plan for one or more business projects, information describing the expected benefits from a partnership, and so on. In such a way, the collaboration objectives (308) represent quantifiable aspects of various goals to be accomplished by the partnership efforts between multiple groups.

In the example method of FIG. 3, receiving (214) one or more key artifacts includes receiving (304) one or more collaboration artifacts (310). In the example method of FIG. 3, the one or more collaboration artifacts (310) may be embodied, for example, as data structures that include information useful evaluating the performance of various functions to be performed as part of a partnership between multiple groups. The one or more collaboration artifacts (310) may include, for example, quantifiable metrics associated with the execution of a strategic plan to be carried out by a partnership, information describing the realized benefits of a partnership, and so on.

In such a way, the collaboration artifacts (310) represent quantifiable metrics that can be used to determine the actual performance of various functions to be performed as part of a partnership between multiple groups.

In the example method of FIG. 3, creating (216) the business recommendation includes creating (306) a collaboration recommendation (312) in dependence upon the collaboration objectives (308) and the collaboration artifacts (310). In the example method of FIG. 3, the collaboration recommendation (312) can include, for example, information forecasting the direct and indirect effects of a partnership between two or more groups, information recommending various changes to the partnership between two or more groups, information recommending various changes to the functions performed by one or more groups in the partnership, and so on. In the example method of FIG. 3, the collaboration recommendation (312) may be delivered to organizational heads and used to determine the nature of the partnership moving forward, and how to best accomplish the goals of the partnership and the goals of the business organizations participating in the partnership.

In the example method of FIG. 3, the collaboration advisor can include sub-components such as a collaboration outcome evaluator configured to forecast potential outcomes from collaboration initiatives, a collaboration alignment evaluator that analyzes the alignment of collaboration initiatives with the defined organizational business goals, a collaboration organizational impact evaluator that consolidates and analyzes information to predict the organizational impacts from collaboration initiatives, and a collaboration analysis engine that calculates the value for a collaboration initiative based on assigned business rules, benefit realization feasibility, organizational business goals, corporate culture compatibility, employee development, enhanced knowledge capital, knowledge/skill application, and other inputs. The collaboration advisor can also include a collaboration measurement evaluator that decomposes the collaboration planning into measurable key performance indicators and metrics so that the benefits of a collaboration initiative can be measured and tracked. The collaboration advisor can also include a collaboration QA contextual evaluator that uses key questions to supply information to the other components of the collaboration advisor.

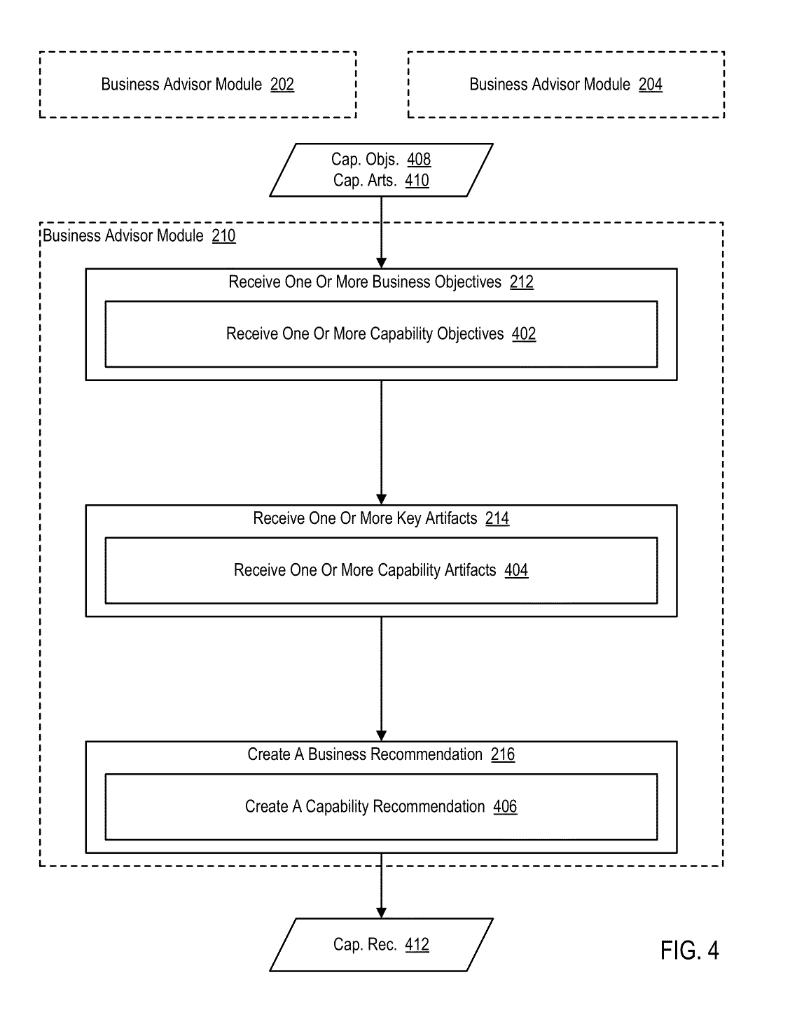

For further explanation, FIG. 4 sets forth a flow chart illustrating an additional example method for providing guidance to a business organization by one or more of a plurality of business advisor modules (202, 204, 210) according to embodiments of the present invention. The example method of FIG. 4 is similar to the example method of FIG. 2, as it also includes receiving (212) one or more business objectives (206), receiving (214) one or more key artifacts (208), and creating (216) a business recommendation (220) in dependence upon the one or more business objectives (206) and the one or more key artifacts (208).

In the example method of FIG. 4, the business advisor module (210) is a capability advisor. In the example method of FIG. 4, a capability advisor may be embodied, for example, as a module of computer program instructions executing on computer hardware. The capability advisor may be configured, for example, to evaluate the skill capabilities, maturity level as an organization, and other readiness factors of a business organization that are needed to capture the full benefits of a business initiative. For example, the capability advisor may evaluate the technical capabilities of a business organization that are needed to capture the full benefits of a business initiative, the financial capabilities of a business organization that are needed to capture the full benefits of a business initiative, the human resources capabilities of a business organization that are needed to capture the full benefits of a business initiative, and so on.

In the example method of FIG. 4, receiving (212) one or more business objectives includes receiving (402) one or more capability objectives (408). In the example method of FIG. 4, the one or more capability objectives (408) may be embodied, for example, as data structures that include information useful in identifying the capabilities needed by a business organization in order to capture the full benefits of a business initiative. The one or more capability objectives (408) may include, for example, information describing the technical capabilities needed by a business organization to capture the full benefits of a business initiative, the financial capabilities needed by a business organization to capture the full benefits of a business initiative, the human resources capabilities needed by a business organization to capture the full benefits of a business initiative, and so on. In such a way, the capability objectives (408) represent quantifiable aspects of various capabilities that a business organization will need to successfully pursue and carry out a desired business initiative.

In the example method of FIG. 4, receiving (214) one or more key artifacts includes receiving (404) one or more capability artifacts (410). In the example method of FIG. 4, the one or more capability artifacts (410) may be embodied, for example, as data structures that include information useful in determining whether a business organization has the necessary capabilities to capture the full benefits of a business initiative. The one or more capability artifacts (410) may include, for example, quantifiable metrics identifying the present technical capabilities of a business organization, quantifiable metrics identifying the human resources capabilities of a business organization, quantifiable metrics identifying the present financial capabilities of a business organization, and so on. In such a way, the capability artifacts (410) represent quantifiable metrics that can be used to determine the actual capabilities of a business organization.

In the example method of FIG. 4, creating (216) the business recommendation includes creating (406) a capability recommendation (412) in dependence upon the capability objectives (408) and the capability artifacts (410). In the example method of FIG. 4, the capability recommendation (412) can include, for example, information specifying capability deficiencies of a business organization, information specify the extent to which various capabilities of the business organization need to be enhanced, information identifying a recommended course of action for enhancing deficient capabilities, and so on. In the example method of FIG. 4, the capability recommendation (412) may be delivered to organizational heads and used to determine the steps needed to bring the capabilities of the business organization up to a level such that the business organization can capture the full benefits of a business initiative.

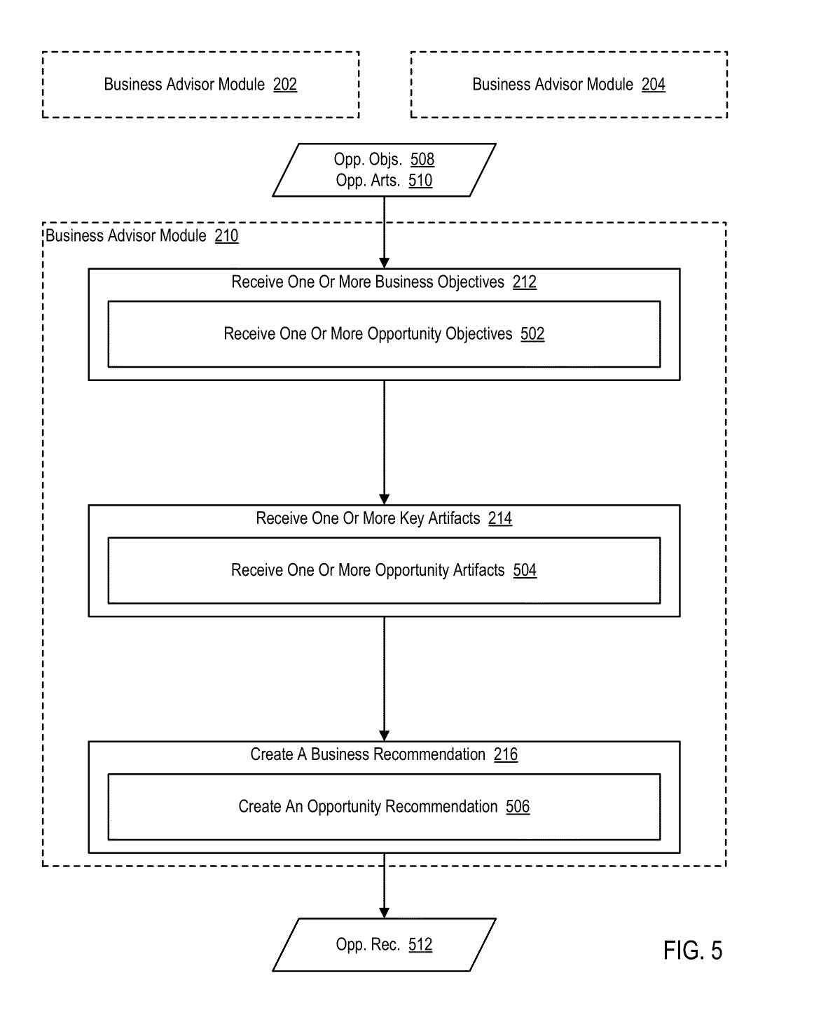

For further explanation, FIG. 5 sets forth a flow chart illustrating an additional example method for providing guidance to a business organization by one or more of a plurality of business advisor modules (202, 204, 210) according to embodiments of the present invention. The example method of FIG. 5 is similar to the example method of FIG. 2, as it also includes receiving (212) one or more business objectives (206), receiving (214) one or more key artifacts (208), and creating (216) a business recommendation (220) in dependence upon the one or more business objectives (206) and the one or more key artifacts (208).

In the example method of FIG. 5, the business advisor module (210) is an opportunity management advisor. In the example method of FIG. 5, an opportunity management advisor may be embodied, for example, as a module of computer program instructions executing on computer hardware. The opportunity management advisor may be configured, for example, to evaluate opportunities that are available to a business organization. For example, the opportunity management advisor may identify the costs associated with pursuing an opportunity, identify the benefits of pursuing the opportunity, identify the likelihood of success in pursuing the opportunity, and so on. In such a way, the opportunity management advisor may assess, rate, and recommend which opportunities to pursue.

In the example method of FIG. 5, receiving (212) one or more business objectives includes receiving (502) one or more opportunity objectives (508). In the example method of FIG. 5, the one or more opportunity objectives (508) may be embodied, for example, as data structures that include information useful in the types of opportunities that a business organization should pursue. The one or more opportunity objectives (508) may include, for example, information describing the rate at which a business organization would like to expand, information identifying target business areas for expansion, information identifying target business areas for contraction, and so on. In such a way, the opportunity objectives (508) represent quantifiable aspects of various business goals and objectives that may be useful in determining whether a particular opportunity is worth pursuing.

In the example method of FIG. 5, receiving (214) one or more key artifacts includes receiving (504) one or more opportunity artifacts (510). In the example method of FIG. 5, the one or more opportunity artifacts (510) may be embodied, for example, as data structures that include information useful in determining whether a business organization should pursue one or more opportunities. The one or more opportunity artifacts (510) may include, for example, quantifiable metrics associated with the forecasted impact of pursuing a particular opportunity such as the forecasted cost of pursing an opportunity, the forecasted benefit of pursuing an opportunity, the forecasted impact on the changes to groups and organizations with the business organization that would result from pursuing an opportunity, and so on. In such a way, the opportunity artifacts (510) represent quantifiable metrics that can be used to determine whether pursuing a particular opportunity would be beneficial for a business organization and whether pursing a particular opportunity would take the business organization closer to or further away from its business goals and objectives.

In the example method of FIG. 5, creating (216) the business recommendation includes creating (506) an opportunity recommendation (512) in dependence upon the opportunity objectives (508) and the opportunity artifacts (510). In the example method of FIG. 5, the opportunity recommendation (512) can include, for example, information outlining the projected impact of pursuing one or more opportunities that will be experienced by the business organization, information ranking the value of a plurality of opportunities to a business organization, information identifying a recommended course of action for pursuing a particular opportunity, and so on. In the example method of FIG. 5, the opportunity recommendation (512) may be delivered to organizational heads and used to determine whether to pursue an opportunity and to determine how to pursue the opportunity.

In the example method of FIG. 5, the opportunity management advisor can include sub-components such as a opportunity outcome evaluator configured to forecast potential outcomes from pursuing a particular opportunity, an opportunity alignment evaluator that analyzes the alignment of pursuing an opportunity with the defined organizational business goals, an opportunity organizational impact evaluator that consolidates and analyzes information to predict the organizational impacts from pursuing a particular opportunity, and an opportunity analysis engine that calculates the value for pursuing a particular opportunity based on assigned business rules, benefit realization feasibility, organizational business goals, corporate culture compatibility, employee development, enhanced knowledge capital, knowledge/skill application, and other inputs. The opportunity management advisor can also include an opportunity measurement evaluator that decomposes pursuing a particular opportunity into measurable key performance indicators and metrics so that the benefits of pursuing a particular opportunity can be measured and tracked. The opportunity management advisor can also include an opportunity QA contextual evaluator that uses key questions to supply information to the other components of the opportunity management advisor.

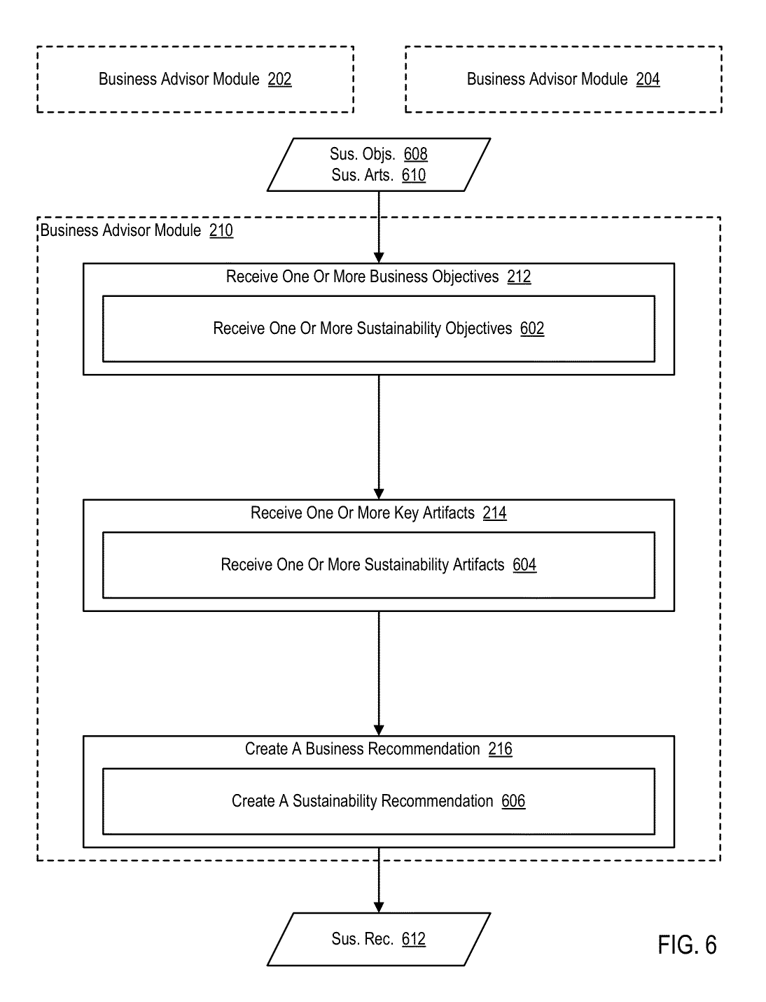

For further explanation, FIG. 6 sets forth a flow chart illustrating an additional example method for providing guidance to a business organization by one or more of a plurality of business advisor modules (202, 204, 210) according to embodiments of the present invention. The example method of FIG. 6 is similar to the example method of FIG. 2, as it also includes receiving (212) one or more business objectives (206), receiving (214) one or more key artifacts (208), and creating (216) a business recommendation (220) in dependence upon the one or more business objectives (206) and the one or more key artifacts (208).

In the example method of FIG. 6, the business advisor module (210) is a sustainability management advisor. In the example method of FIG. 6, a sustainability management advisor may be embodied, for example, as a module of computer program instructions executing on computer hardware. The sustainability management advisor may be configured, for example, to evaluate and manage sustainability initiatives of a business organization. Such sustainability initiatives can include, for example, initiatives to decrease environmental waste, initiatives to increase the usage of green/renewable energy, and other environmentally beneficial initiatives. For example, the sustainability management advisor may identify the costs associated with pursuing a sustainability initiative, identify the benefits of pursuing the sustainability initiative, identify the resources that will be need to carry out a sustainability initiative, identify the impact of the sustainability initiative on worker production, and so on. In such a way, the sustainability management advisor may assess, rate, and recommend which sustainability initiatives to pursue and may recommend a course of action for pursuing a particular sustainability initiative.

In the example method of FIG. 6, receiving (212) one or more business objectives includes receiving (602) one or more sustainability objectives (608). In the example method of FIG. 6, the one or more sustainability objectives (608) may be embodied, for example, as data structures that include information useful in evaluating the impact of pursuing various sustainability initiatives. The one or more sustainability objectives (608) may include, for example, information describing various goals of any sustainability initiatives, information describing the amount of resources available for pursuing sustainability initiatives, and so on. In such a way, the sustainability objectives (608) represent quantifiable aspects of various sustainability goals and constraints that may be useful in determining whether a particular sustainability initiative is worth pursuing.

In the example method of FIG. 6, receiving (214) one or more key artifacts includes receiving (604) one or more sustainability artifacts (610). In the example method of FIG. 6, the one or more sustainability artifacts (610) may be embodied, for example, as data structures that include information useful in determining whether a business organization should pursue one or more sustainability initiatives. The one or more sustainability artifacts (610) may include, for example, quantifiable metrics associated with the forecasted impact of pursuing a particular sustainability initiative such as the forecasted cost of pursing a sustainability initiative, the forecasted benefit of pursuing a sustainability initiative, the forecasted marketing and public relations impact that would result from pursuing a sustainability initiative, and so on. In such a way, the sustainability artifacts (610) represent quantifiable metrics that can be used to determine whether pursuing a particular sustainability initiative would be beneficial for a business organization and whether pursing a particular sustainability initiative would take the business organization closer to or further away from its goals and objectives.

In the example method of FIG. 6, creating (216) the business recommendation includes creating (606) a sustainability recommendation (612) in dependence upon the sustainability objectives (608) and the sustainability artifacts (610). In the example method of FIG. 6, the sustainability recommendation (612) can include, for example, information outlining the projected impact of pursuing one or more sustainability initiatives that will be experienced by the business organization, information ranking the value of a plurality of sustainability initiatives to a business organization, information identifying a recommended course of action for pursuing a particular sustainability initiative, and so on. In the example method of FIG. 6, the sustainability recommendation (612) may be delivered to organizational heads and used to determine whether to pursue a sustainability initiative and to determine how to pursue the sustainability initiative.

In the example method of FIG. 6, the sustainability management advisor can include sub-components such as a sustainability outcome evaluator configured to forecast potential outcomes from sustainability initiatives, a sustainability alignment evaluator that analyzes the alignment of sustainability initiatives with the defined organizational business goals, a sustainability organizational impact evaluator that consolidates and analyzes information to predict the organizational impacts from sustainability initiatives, and a sustainability analysis engine that calculates the value for a sustainability initiative based on assigned business rules, benefit realization feasibility, organizational business goals, corporate culture compatibility, employee development, enhanced knowledge capital, knowledge/skill application, and other inputs. The sustainability management advisor can also include a sustainability measurement evaluator that decomposes the sustainability initiative planning into measurable key performance indicators and metrics so that the benefits of a sustainability initiative can be measured and tracked. The sustainability management advisor can also include a sustainability QA contextual evaluator that uses key questions to supply information to the other components of the sustainability management advisor.

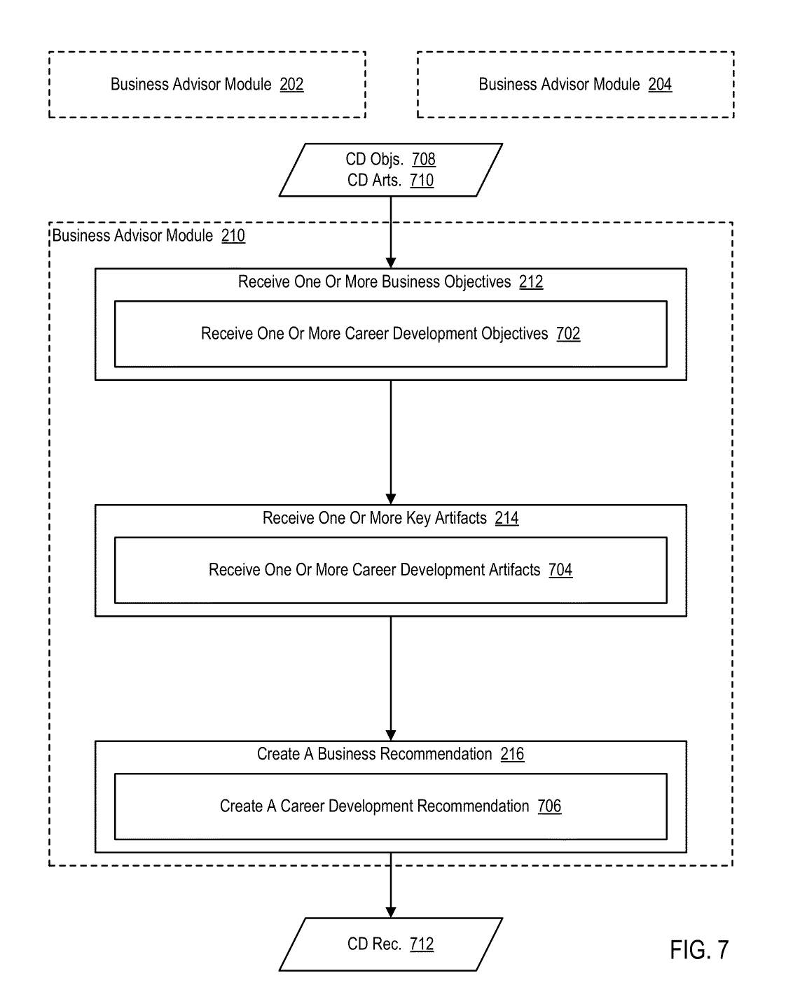

For further explanation, FIG. 7 sets forth a flow chart illustrating an additional example method for providing guidance to a business organization by one or more of a plurality of business advisor modules (202, 204, 210) according to embodiments of the present invention. The example method of FIG. 7 is similar to the example method of FIG. 2, as it also includes receiving (212) one or more business objectives (206), receiving (214) one or more key artifacts (208), and creating (216) a business recommendation (220) in dependence upon the one or more business objectives (206) and the one or more key artifacts (208).

In the example method of FIG. 7, the business advisor module (210) is a career development advisor. In the example method of FIG. 7, a career development advisor may be embodied, for example, as a module of computer program instructions executing on computer hardware. The career development advisor may be configured, for example, to evaluate and manage career development initiatives for employees of a business organization. Such career development initiatives can include, for example, training programs, educational programs, mentorship programs, and so on. The career development advisor may further be configured to account for quantifiable aspects of a business organization's goals, such that career development initiatives are evaluated in light of the overall goals of the business organization. In such a way, the career development advisor may assess, rate, and recommend which career development initiatives to pursue and may recommend a course of action for pursuing a particular career development initiative.

In the example method of FIG. 7, receiving (212) one or more business objectives includes receiving (702) one or more career development objectives (708). In the example method of FIG. 7, the one or more career development objectives (708) may be embodied, for example, as data structures that include information useful in evaluating the impact of pursuing various career development initiatives. The one or more career development objectives (708) may include, for example, information describing the career advancement goals of a specific employee of the business organization, information describing the human resources needs of the business organization, information describing the available resources that the business organization can dedicate to career development initiatives, and so on. In such a way, the career development objectives (708) represent quantifiable aspects of an employee's career advancement goals, a business organization's needs, and the resources and constraints that exist for use in pursuing the employee's career advancement goals and the business organization's interests.

In the example method of FIG. 7, receiving (214) one or more key artifacts includes receiving (704) one or more career development artifacts (710). In the example method of FIG. 7, the one or more career development artifacts (710) may be embodied, for example, as data structures that include information useful in determining whether a business organization should pursue one or more career development initiatives. The one or more career development artifacts (710) may include, for example, quantifiable metrics associated with the forecasted impact of pursuing a particular career development initiative such as the forecasted cost of pursuing a career development initiative, the forecasted benefit of pursuing a career development initiative, the forecasted employee retention impact that would result from pursuing a career development initiative, information describing the current skill set of a specific employee of the business organization, and so on. In such a way, the career development artifacts (710) represent quantifiable metrics that can be used to determine whether pursuing a particular career development initiative would be beneficial for a business organization and whether pursing a particular career development initiative would take the business organization and the employee closer to or further away from their goals and objectives.

In the example method of FIG. 7, creating (216) the business recommendation includes creating (706) a career development recommendation (712) in dependence upon the career development objectives (708) and the career development artifacts (710). In the example method of FIG. 7, the career development recommendation (712) can include, for example, information outlining the projected impact of pursuing one or more career development initiatives that will be experienced by the business organization and the employee, information ranking the value of a plurality of career development initiatives to a business organization, information identifying a recommended course of action for pursuing a particular career development initiative, and so on. In the example method of FIG. 7, the career development recommendation (712) may be delivered to organizational heads and used to determine whether to pursue a career development initiative and to determine how to pursue the career development initiative.

In the example method of FIG. 7, the career development advisor can include sub-components such as a career development outcome evaluator configured to forecast potential outcomes from career development training, a career development alignment evaluator that analyzes the alignment of career development planning with the defined organizational business goals, a career development organizational impact evaluator that consolidates and analyzes information to predict the organizational impacts from career development planning, and a career development analysis engine that calculates the value for a career development plan based on assigned business rules, benefit realization feasibility, organizational business goals, corporate culture compatibility, employee development, enhanced knowledge capital, knowledge/skill application, and other inputs. The career development advisor can also include a career development measurement evaluator that decomposes the career development planning into measurable key performance indicators and metrics so that the benefits of a career development initiative can be measured and tracked. The career development advisor can also include a career development QA contextual evaluator that uses key questions to supply information to the other components of the career development advisor.

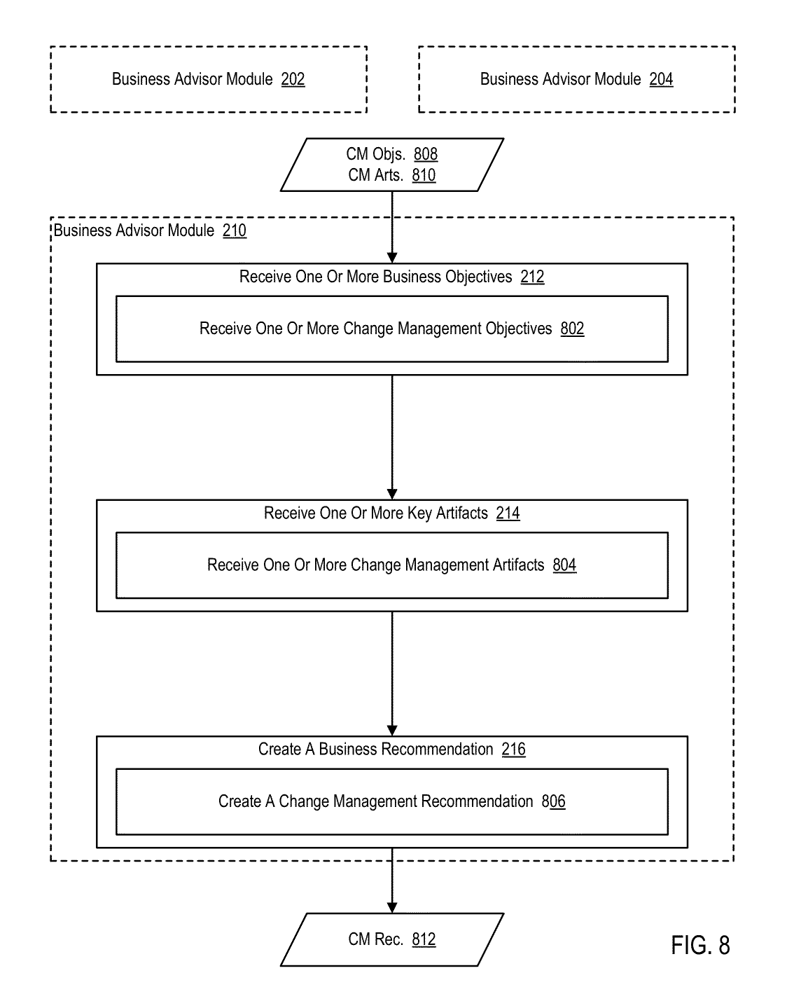

For further explanation, FIG. 8 sets forth a flow chart illustrating an additional example method for providing guidance to a business organization by one or more of a plurality of business advisor modules (202, 204, 210) according to embodiments of the present invention. The example method of FIG. 8 is similar to the example method of FIG. 2, as it also includes receiving (212) one or more business objectives (206), receiving (214) one or more key artifacts (208), and creating (216) a business recommendation (220) in dependence upon the one or more business objectives (206) and the one or more key artifacts (208).

In the example method of FIG. 8, the business advisor module (210) is a change management advisor. In the example method of FIG. 8, a change management advisor may be embodied, for example, as a module of computer program instructions executing on computer hardware. The change management advisor may be configured, for example, to evaluate and manage change initiatives of a business organization. Such change initiatives can include, for example, initiatives to change the organizational structure of a business organization, initiatives to change the technical infrastructure that supports the business organization, initiatives to change the strategic objectives of a business organization, and other changes that take a business organization from a first state to a second state. For example, the change management advisor may identify the costs associated with pursuing a change initiative, identify the benefits of pursuing the change initiative, identify the resources that will be need to carry out a change initiative, identify the impact of the change initiative on worker production, and so on. In such a way, the change management advisor may assess, rate, and recommend which change initiatives to pursue and may recommend a course of action for pursuing a particular change initiative.

In the example method of FIG. 8, receiving (212) one or more business objectives includes receiving (802) one or more change objectives (808). In the example method of FIG. 8, the one or more change objectives (808) may be embodied, for example, as data structures that include information useful in evaluating the impact of pursuing various change initiatives. The one or more change objectives (808) may include, for example, information describing various goals of any change initiatives, information describing the amount of resources available for pursuing change initiatives, and so on. In such a way, the change objectives (808) represent quantifiable aspects of various goals and constraints that may be useful in determining whether a particular change initiative is worth pursuing.

In the example method of FIG. 8, receiving (214) one or more key artifacts includes receiving (804) one or more change artifacts (810). In the example method of FIG. 8, the one or more change artifacts (810) may be embodied, for example, as data structures that include information useful in determining whether a business organization should pursue one or more change initiatives. The one or more change artifacts (810) may include, for example, quantifiable metrics associated with the forecasted impact of pursuing a particular change initiative such as the forecasted cost of pursing a change initiative, the forecasted benefit of pursuing a change initiative, the forecasted human resources impact that would result from pursuing a change initiative, and so on. In such a way, the change artifacts (810) represent quantifiable metrics that can be used to determine whether pursuing a particular change initiative would be beneficial for a business organization and whether pursing a particular change initiative would take the business organization closer to or further away from its goals and objectives.

In the example method of FIG. 8, creating (216) the business recommendation includes creating (806) a change recommendation (812) in dependence upon the change objectives (808) and the change artifacts (810). In the example method of FIG. 8, the change recommendation (812) can include, for example, information outlining the projected impact of pursuing one or more change initiatives that will be experienced by the business organization, information ranking the value of a plurality of change initiatives to a business organization, information identifying a recommended course of action for pursuing a particular change initiative, and so on. In the example method of FIG. 8, the change recommendation (812) may be delivered to organizational heads and used to determine whether to pursue a change initiative and to determine how to pursue the change initiative.

In the example method of FIG. 8, the change management advisor can include sub-components such as a change outcome evaluator configured to forecast potential outcomes from pursuing a change initiative, a change alignment evaluator that analyzes the alignment of pursuing a change initiative with the defined organizational business goals, a change organizational impact evaluator that consolidates and analyzes information to predict the organizational impacts from pursuing a change initiative, and a change analysis engine that calculates the value for pursuing a change initiative based on assigned business rules, benefit realization feasibility, organizational business goals, corporate culture compatibility, employee development, enhanced knowledge capital, knowledge/skill application, and other inputs. The change management advisor can also include a change measurement evaluator that decomposes pursuing a change initiative into measurable key performance indicators and metrics so that the benefits of pursuing a change initiative can be measured and tracked. The change management advisor can also include a change QA contextual evaluator that uses key questions to supply information to the other components of the change management advisor.

Example embodiments of the present invention are described largely in the context of a fully functional computer system for providing guidance to a business organization by one or more of a plurality of business advisor modules. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of providing guidance to a business organization by one or more of a plurality of business advisor modules, the method comprising:
receiving, by a business advisor module, one or more business objectives;
receiving, by the business advisor module, one or more key artifacts; and
creating, by the business advisor module in dependence upon the one or more business objectives and the one or more key artifacts, a business recommendation.

2. The method of claim 1 wherein:
the business advisor module is a collaboration advisor;
receiving one or more business objectives includes receiving one or more collaboration objectives;
receiving one or more key artifacts includes receiving one or more collaboration artifacts; and
creating the business recommendation includes creating a collaboration recommendation in dependence upon the collaboration objectives and the collaboration artifacts.

3. The method of claim 1 wherein:
the business advisor module is a capability advisor;
receiving one or more business objectives includes receiving one or more capability objectives;
receiving one or more business objectives includes receiving one or more capability artifacts; and
creating the business recommendation includes creating a capability recommendation.

4. The method of claim 1 wherein:
the business advisor module is an opportunity management advisor;
receiving one or more business objectives includes receiving one or more opportunity objectives;
receiving one or more business objectives includes receiving one or more opportunity artifacts; and
creating the business recommendation includes creating an opportunity recommendation.

5. The method of claim 1 wherein:
the business advisor module is a sustainability management advisor;
receiving one or more business objectives includes receiving one or more sustainability objectives;
receiving one or more business objectives includes receiving one or more sustainability artifacts; and
creating the business recommendation includes creating a sustainability recommendation.

6. The method of claim 1 wherein:
the business advisor module is a career development advisor;
receiving one or more business objectives includes receiving one or more career development objectives;
receiving one or more business objectives includes receiving one or more career development artifacts; and
creating the business recommendation includes creating a career development recommendation.

7. The method of claim 1 wherein:
the business advisor module is a change management advisor;
receiving one or more business objectives includes receiving one or more change management objectives;
receiving one or more business objectives includes receiving one or more change management artifacts; and
creating the business recommendation includes creating a change management recommendation.

8. An apparatus for providing guidance to a business organization by one or more of a plurality of business advisor modules, the apparatus comprising a computer processor, a computer memory operatively coupled to the computer processor, the computer memory having disposed within it computer program instructions that, when executed by the computer processor, cause the apparatus to carry out the steps of:
receiving, by a business advisor module, one or more business objectives;
receiving, by the business advisor module, one or more key artifacts; and
creating, by the business advisor module in dependence upon the one or more business objectives and the one or more key artifacts, a business recommendation.

9. The apparatus of claim 8 wherein:
the business advisor module is a collaboration advisor;
receiving one or more business objectives includes receiving one or more collaboration objectives;
receiving one or more key artifacts includes receiving one or more collaboration artifacts; and
creating the business recommendation includes creating a collaboration recommendation in dependence upon the collaboration objectives and the collaboration artifacts.

10. The apparatus of claim 8 wherein:
the business advisor module is a capability advisor;
receiving one or more business objectives includes receiving one or more capability objectives;
receiving one or more business objectives includes receiving one or more capability artifacts; and
creating the business recommendation includes creating a capability recommendation.

11. The apparatus of claim 8 wherein:
the business advisor module is an opportunity management advisor;
receiving one or more business objectives includes receiving one or more opportunity objectives;
receiving one or more business objectives includes receiving one or more opportunity artifacts; and
creating the business recommendation includes creating an opportunity recommendation.

12. The apparatus of claim 8 wherein:
the business advisor module is a sustainability management advisor;
receiving one or more business objectives includes receiving one or more sustainability objectives;
receiving one or more business objectives includes receiving one or more sustainability artifacts; and
creating the business recommendation includes creating a sustainability recommendation.

13. The apparatus of claim 8 wherein:
the business advisor module is a career development advisor;
receiving one or more business objectives includes receiving one or more career development objectives;
receiving one or more business objectives includes receiving one or more career development artifacts; and
creating the business recommendation includes creating a career development recommendation.

14. The apparatus of claim 8 wherein:
the business advisor module is a change management advisor;
receiving one or more business objectives includes receiving one or more change management objectives;
receiving one or more business objectives includes receiving one or more change management artifacts; and
creating the business recommendation includes creating a change management recommendation.

15. A computer program product for providing guidance to a business organization by one or more of a plurality of business advisor modules, the computer program product disposed upon a computer readable medium, the computer program product comprising computer program instructions that, when executed, cause a computer to carry out the steps of:
receiving, by a business advisor module, one or more business objectives;
receiving, by the business advisor module, one or more key artifacts; and
creating, by the business advisor module in dependence upon the one or more business objectives and the one or more key artifacts, a business recommendation.

16. The computer program product of claim 15 wherein:
the business advisor module is a collaboration advisor;
receiving one or more business objectives includes receiving one or more collaboration objectives;
receiving one or more key artifacts includes receiving one or more collaboration artifacts; and
creating the business recommendation includes creating a collaboration recommendation in dependence upon the collaboration objectives and the collaboration artifacts.

17. The computer program product of claim 15 wherein:
the business advisor module is a capability advisor;
receiving one or more business objectives includes receiving one or more capability objectives;
receiving one or more business objectives includes receiving one or more capability artifacts; and
creating the business recommendation includes creating a capability recommendation.

18. The computer program product of claim 15 wherein:
the business advisor module is an opportunity management advisor;
receiving one or more business objectives includes receiving one or more opportunity objectives;
receiving one or more business objectives includes receiving one or more opportunity artifacts; and
creating the business recommendation includes creating an opportunity recommendation.

19. The computer program product of claim 15 wherein:
the business advisor module is a sustainability management advisor;
receiving one or more business objectives includes receiving one or more sustainability objectives;
receiving one or more business objectives includes receiving one or more sustainability artifacts; and
creating the business recommendation includes creating a sustainability recommendation.

20. The computer program product of claim 15 wherein:
the business advisor module is a career development advisor;
receiving one or more business objectives includes receiving one or more career development objectives;
receiving one or more business objectives includes receiving one or more career development artifacts; and
creating the business recommendation includes creating a career development recommendation.

21. The computer program product of claim 15 wherein:
the business advisor module is a change management advisor;
receiving one or more business objectives includes receiving one or more change management objectives;
receiving one or more business objectives includes receiving one or more change management artifacts; and
creating the business recommendation includes creating a change management recommendation.
